(19) United States
(12) Patent Application Publication
(10) Pub. No.: US 2026/0257745 A1
(43) Pub. Date: Sep. 3, 2026

(54) Motorcycle

(71) Applicant: Bayerische Motoren Werke Aktiengesellschaft, Muenchen (DE)

(72) Inventors: Arnd DIPPEL, Muenchen (DE); Josef MAECHLER, Moosleerau (CH)

(21) Appl. No.: 19/489,941

(22) PCT Filed: Sep. 2, 2024
(86) PCT No.: PCT/EP2024/074448

§ 371 Date: Dec. 4, 2025

(30) Foreign Application Priority Data
Sep. 15, 2023 (DE) 10 2023 124 993.2

(51) Int. Cl. B62J 50/22; F16H 59/24; F16H 59/36; F16H 59/38; F16H 59/44; F16H 59/70; F16H 61/04; F16H 61/682

(52) U.S. Cl. CPC B62J 50/22; F16H 61/04; F16H 61/682; F16H 59/24; F16H 2059/366; F16H 59/38; F16H 59/44; F16H 59/70

(57) ABSTRACT

A motorcycle has an engine and a manual gearbox which are connected via a clutch. The motorcycle has a first unit which is designed to assist the rider of the motorcycle when shifting without clutch actuation. The motorcycle has a second unit which is designed to calculate a shifting time. A display is provided for displaying and/or communicating the shifting time to the rider.

### BACKGROUND AND SUMMARY

The present invention relates to a motorcycle, for example a motorbike.

In particular, the invention concerns motorcycles that have so-called shift automation means. Such shift automation means assist the rider when performing clutch-free shifts. These systems are also known as “quickshifters” or “blippers”. Quickshifters make it possible to shift to a higher gear without releasing the throttle and without operating the clutch. For this purpose, the ignition or injection is interrupted for a very short time. By contrast, blippers allow downshifting to a lower gear. For this purpose, during overrun operation, the engine rotational speed is increased by brief intermediate application of the throttle. Downshifting, that is to say the blipper functionality, constitutes a particularly great challenge, in particular if the shift point is chosen incorrectly by the rider and the rotational speed is not suitable, or the automatic rotational speed adjustment is not sufficient. Shifting then occurs with a jerk, and is perceived to be extremely uncomfortable. Gear disengagement may even occur under certain circumstances.

It is therefore an object of the present invention to provide a motorcycle which optimizes clutch-free shifting, in particular downshifting, in relation to the prior art.

The object is achieved by means of a motorcycle according to the independent claim(s). Further advantages and features are apparent from the dependent claims, from the description and from the appended figure.

According to the invention, a motorcycle, for example a motorbike, comprises an engine, in particular an internal combustion engine, and a transmission that are connected via a clutch, wherein the motorcycle has a first device which is configured to assist the rider of the motorcycle when performing clutch-free shifts, that is to say shifts without actuating the clutch, and wherein the motorcycle has a second device which is configured to calculate, in particular precalculate, a shift time. The motorcycle has a display for displaying and/or communicating the shift time to the rider. The transmission is one which is or must be actively actuated by the rider in order to perform a shift operation. In principle, it is necessary for the clutch to be operated and the desired gear engaged. The first device may be a quickshifter, a blipper or a shift automation system, wherein a shift automation system is to be understood here to mean a system which provides both the function of a quickshifter and that of a blipper. Quickshifters make it possible to shift to a higher gear without releasing the throttle and without operating the clutch. For this purpose, the ignition and/or injection is briefly interrupted, whereby the load is withdrawn from the transmission, and the next gear can be engaged. By contrast, blippers allow downshifting to a lower gear. Here, too, the load is withdrawn from the transmission. This is, however, performed by means of a brief increase of the engine rotational speed (intermediate application of the throttle). The functionalities both of the quickshifter and of the blipper, and the technical implementations thereof, are known in principle from the prior art, and will therefore not be discussed in detail here.

The second device is advantageously configured to calculate shift times for upshifting and/or downshifting. Specifically downshifting to lower gears, for example from the second gear to the first gear, constitutes a challenge, because it is in this situation that the rotational speed steps are greatest.

The calculation of the shift times is preferably adjustable. During normal on-road riding, a target variable for the calculation of the shift times may for example be comfort. It is then the intention for the shift operation to be performed with the least possible jerk. During riding on a racetrack, a target variable may for example be shift safety. This means that the gearshift can be performed reliably and with adequate precision. In particular, downshifting to lower gears often proves to be difficult, in particular if the shift point is chosen incorrectly by the rider and the rotational speed is not suitable, or the automatic rotational speed adjustment (intermediate application of the throttle) is not sufficient. Downshifting from the second gear to the first gear constitutes a particular challenge, because in this situation the rotational speed step is relatively great. Specifically in the case of high-speed riding, for example on a racetrack, gear disengagement may consequently occur. This means that the engaged gear possibly disengages again, which can give rise to a difficult riding situation for the rider. By means of the second device, it is advantageously possible for a suitable shift time to be calculated and displayed to the rider. It can thus be signaled to the rider when they should perform a shift in order that the gearshift can be performed safely.

The second device is expediently configured to identify and signalize or display an impending shift operation. The second device is expediently configured to identify, for example on the basis of the evaluation of the traveling speed, whether upshifting or downshifting is to be performed imminently. Accordingly, an optimum shift time for the next impending shift operation is precalculated and displayed.

The second device is expediently also configured to display the attainment of the ideal shift time by means of the display.

The controller is expediently configured to detect and/or calculate various operating parameters in order to determine the shift time. It is thus possible, inter alia, to implement a clear distinction between upshifting and downshifting, to identify different riding situations, and the current traveling state of the motorcycle (engine rotational speed, engaged gear, mode of operation, riding situation, etc.).

The various operating parameters are expediently at least selected from the following: vehicle speed, engine rotational speed, transmission rotational speed, throttle valve position, gear stage, etc. These operating parameters may expediently be processed by the controller such that an ideal shift time can be calculated, in particular precalculated, from a comfort aspect. High shift comfort is distinguished in particular by the smoothest possible engagement of a gear. The vehicle acceleration advantageously remains as constant as possible during the shift operation.

As already indicated, the first device may be a system that provides assistance during upshifting, may be a system that provides assistance during downshifting, and may be a system that provides assistance both during upshifting and during downshifting. It is basically pointed out that, in the present case, upshifting is less problematic, in particular from a comfort aspect. Downshifting, in particular to lower gears, constitutes a particular challenge. In the present case, however, this can expediently be optimized by means of the second device such that comfort is maximized or can at least be reliably implemented. In particular, it can be ensured that the gearshift takes place with the required precision, such that the gear cannot disengage.

The first device is expediently configured to influence, in particular reduce and/or increase, the engine rotational speed. In the case of upshifting, the influencing of the engine rotational speed may for example be implemented by means of a brief interruption of the ignition and/or of the injection. In the case of downshifting, the engine rotational speed is achieved by means of a short application of the throttle, for example by means of a brief increase in the injection quantity.

In one embodiment, the display is configured to communicate by acoustic, visual and/or haptic means. The display is expediently integrated into the motorcycle, for example into the cockpit thereof, in the form of a display unit. The display may alternatively or additionally be integrated into the rider's equipment, for example into an item of clothing or into a component that is arranged or arrangeable separately on the vehicle. In one embodiment, the “shift flash” that is known from the prior art may for example be used for display purposes. The shift flash is understood as a device which is configured to communicate information by way of an optical signal. In a preferred embodiment, the shift flash is designed as a luminaire or a lamp which is configured to output a light signal when the rider is to perform a shift. The shift flash is preferably configured to use a different color of light signal for upshifting than for downshifting.

In one embodiment, the controller is configured to use a different form of presentation for upshifting than for downshifting. In the case of the aforementioned shift flash, use is for example made of different colors for upshifting and for downshifting.

Further advantages and features will become apparent from the following description of an embodiment of a display of a motorcycle according to the invention.

### BRIEF DESCRIPTION OF THE DRAWING

FIG. 1 is a schematic view of an embodiment of a display of a motorcycle according to the invention.

### DETAILED DESCRIPTION OF THE DRAWING

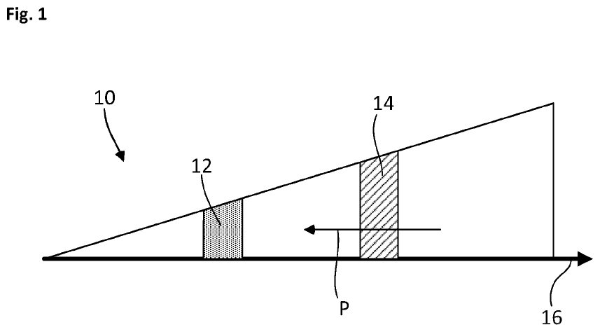

FIG. 1 is a schematic illustration of a display 10 in which an ideal shift time 12 is indicated in accordance with an operating parameter 16. The operating parameter 16 is for example the traveling speed. This increases from left to right. The reference sign 14 denotes a present operating point, that is to say in this case the speed at which the rider on their motorcycle is presently moving. The arrow with the reference sign P indicates that the rider is presently reducing their speed. The second device calculates the ideal shift time 12, for example in accordance with the present traveling speed, the engine rotational speed and the transmission rotational speed and taking into consideration the engaged gear stage. The rider can thus recognize that they should optimally perform a shift, in the present case in particular a downshift because the traveling speed is being reduced, when the field denoted by the reference sign 12 is reached. It may be possible that the field denoted by the reference sign 12 “moves”, or departs from its position, or even disappears, depending on the operating parameters. If the rider accelerates, the field 12 may for example disappear or move to the right. In the case of the display 10 depicted here, the shift time is not only displayed but also signalized. The field 12 may also be positioned entirely differently. In particular, it may for example be arranged in the form of a (separate) luminaire or lamp (shift flash) in the region of a cockpit. The second device can advantageously optimally assist the rider when performing the shift operation, in particular when downshifting (but also when upshifting), in that the nearing and/or attainment of the shift point, or the corresponding rotational speed, can be signaled, even on a gear-dependent basis. The signaling may be implemented in acoustic, haptic and/or visual form, in a manner integrated into the vehicle or integrated into the rider's equipment, or by means of a device worn by the rider, for example also in the form of the shift flash that is already known from the prior art. Here, a distinction between upshifting and downshifting should advantageously be provided, for example by using different colors for the aforementioned shift flash. It is expediently thus possible to achieve improved comfort, in particular in the case of two-person riding, and a sportier feel in the case of solo riding and riding on a racetrack. At the same time, the signaling ensures and teaches safer downshifting down to the first gear.

### LIST OF REFERENCE SIGNS

10 Display
12 (Ideal) shift time, field
14 Present operating point
16 Operating parameter
P Arrow

1.-10. (canceled)

11. A motorcycle, comprising:
an engine and a transmission that are connected via a clutch;
a first device configured to assist a rider of the motorcycle when performing shifts without actuating the clutch;
a second device configured to calculate a shift time; and
a display that displays and/or communicates the shift time to the rider.

12. The motorcycle according to claim 11, wherein the second device is configured to calculate shift times for upshifting and/or downshifting.

13. The motorcycle according to claim 11, wherein the calculation of the shift times is adjustable.

14. The motorcycle according to claim 13, wherein a target variable for the calculation of the shift times is comfort and/or shift safety.

15. The motorcycle according to claim 11, wherein the second device is configured to identify and signalize an impending shift operation.

16. The motorcycle according to claim 11, wherein the second device is configured to detect and/or calculate various operating parameters in order to determine the shift time.

17. The motorcycle according to claim 16, wherein the various operating parameters are selected from a group comprising: vehicle speed, engine rotational speed, transmission rotational speed, throttle valve position, and gear stage.

18. The motorcycle according to claim 11, wherein the first device is configured to reduce and/or increase engine rotational speed of the engine.

19. The motorcycle according to claim 11, wherein the display is configured to communicate by acoustic, visual and/or haptic means.

20. The motorcycle according to claim 19, wherein the display is configured to use a different form of presentation or communication for upshifting than for downshifting.
